(19) United States
(12) Patent Application Publication
(10) Pub. No.: US 2014/0010479 A1
(43) Pub. Date: Jan. 9, 2014

(54) BILINEAR INTERPOLATION CIRCUIT FOR IMAGE AND METHOD THEREOF

(71) Applicant: SAMSUNG ELECTRO-MECHANICS CO., LTD., Gyeonggi-do (KR)

(72) Inventors: TAE HYEON KWON, Gyeonggi-do (KR); GYU WON KIM, Gyeonggi-do (KR); KYOUNG JOONG MIN, Gyeonggi-do (KR)

(73) Assignee: SAMSUNG ELECTRO-MECHANICS CO., LTD., Gyeonggi-do (KR)

(21) Appl. No.: 13/831,039

(22) Filed: Mar. 14, 2013

(30) Foreign Application Priority Data
Jul. 9, 2012 (KR) 10-2012-0074570

(51) Int. Cl. G06T 3/40

(52) U.S. Cl. CPC G06T 3/4007
USPC 382/300

(57) ABSTRACT

Disclosed herein are a bilinear interpolation circuit for an image and a method thereof. The bilinear interpolation method for ran image according to an exemplary embodiment of the present invention includes: increasing an input clock of a camera two times by a PLL; reading a plurality of reference pixels to be interpolated from the memory while storing input images (pixels) in the memory by the memory control unit, matching a clock timing increased two times; calculating pixel values to be corrected by an arithmetic operation by the data interpolation unit based on the read pixel (image) data; and outputting the calculated pixel values to be corrected by the output format conversion unit, matching an original clock speed.

### CROSS REFERENCE(S) TO RELATED APPLICATIONS

This application claims the benefit: under 35 U.S.C. Section 119 of Korean Patent Application Serial No. 10-2012-0074570, entitled “Bilinear Interpolation Circuit For Image And Method Thereof” filed on Jul. 09, 2012, which is hereby incorporated by reference in its entirety into this application.

### BACKGROUND OF THE INVENTION

1. Technical Field

for an image and a method thereof, and more particularly, to a bilinear interpolation circuit for an image and a method thereof capable of shortening data processing time by reading a plurality of data referenced for interpolation from a memory while writing input image data in the memory.

2. Description of the Related Art

Recently, a camera has frequently used a wide angle lens in an electronic camera or surveillance camera field. Therefore, a distortion correction circuit for an image is needed so as to improve image quality. In addition, a calibration correction circuit for input images according to an installation angle and a position of a camera, a geometrical conversion circuit used to adjust a point-of-view of an image seen to a user, a resolution conversion circuit for magnifying an image size, and the like, according to applications have been mainly used. The circuits obtain new image pixel values by using an interpolation circuit that sequentially stores most input image data in a memory and then calculates coordinates to be referenced to obtain pixel values to be newly generated and multiplies predetermined weights by image data of the calculated reference coordinates.

An interpolation method used for a magnification of an image, a distortion correction of an image, a geometrical conversion of an image, and the like, may be variously classified into neighbor pixel interpolation, linear interpolation, cubic interpolation, and the like, according to an algorithm. Generally, the most used interpolation method is the very bi-linear interpolation method having an advantage in terms of complexity and performance. The bilinear interpolation method may be easily configured in hardware and have excellent characteristics. In an image, the bilinear interpolation circuit is a circuit essentially used to perform the resolution conversion and the geometrical conversion of an image or the distortion correction of an image due to a lens.

However, the bilinear interpolation circuit according to the related art has a problem in that real-time processing time is increased due to an increase in accessibility to a memory and a size of hardware is large due to the separate performance of horizontal and vertical interpolation.

### RELATED ART DOCUMENT

[Patent Document]

(Patent Document 1) Korea Patent Laid-Open Publication No. 10-2005-0055591

(Patent Document 2) Korea Patent Laid-Open Publication No. 10-2011-0042025

(Patent Document 3) JP Patent Laid-Open Publication No. 2011-199359

### SUMMARY OF THE INVENTION

An object of the present invention is to provide a bilinear interpolation circuit and a method thereof capable of reducing data processing time and a hardware size by reading a plurality of data referenced for interpolation from a memory while writing input image data in a memory in a configuration of the bilinear interpolation circuit.

Another object of the present invention is to provide a bilinear interpolation circuit for an image and a method thereof capable of saving costs by performing a distortion correction or a geometrical conversion of an image with a single field programmable gate array (FPGA) or an application specific IC (ASIC) without adding an external memory according to an easy design of hardware and development environment.

According to an exemplary embodiment of the present invention, there is provided a bilinear interpolation circuit for an image, including: a memory in which input image data and reference pixel data for interpolation are stored; a memory control unit storing the input image data in the memory and reading the reference pixel data from the memory for interpolation of an image; an interpolation coefficient generation unit calculating coordinate values to be corrected for each pixel to generate interpolation coefficients; and a data interpolation unit calculating pixel values to be corrected from the reference pixels read by the memory control unit based on the interpolation coefficients generated by the interpolation coefficient generation unit, wherein the memory is formed of an SRAM having a single input and output port and the memory control unit reads the plurality of reference pixels to be interpolated from the memory while storing the input image data in the memory.

The memory control unit may read four reference pixels to be interpolated from the memory while storing the input image data in the memory.

The bilinear interpolation circuit may further include: a phase locked loop (PLL) increasing an input clock of a camera two times and providing the increased input clock to the memory control unit, the interpolation coefficient generation unit, and the data interpolation unit; a shift buffer register transmitting the input image data to the memory control unit while overlappingly storing the input image data, Matching the input clock; a memory address generation unit generating memory addresses to be referenced and providing the generated memory addresses to the memory control unit; and an output format conversion unit outputting pixel values to be corrected calculated by the data interpolation unit, matching an original clock speed.

According to another exemplary embodiment of the present invention, there is provided a bilinear interpolation method for an memory, a memory control unit, an interpolation coefficient generation unit, and a data interpolation unit, the bilinear interpolation method including: a) increasing an input clock of a camera two times by a PLL; b) reading a plurality of reference pixels to be interpolated from the memory while storing input images (pixels) in the memory by the memory control unit, matching a clock timing increased two times; c) calculating pixel values to be corrected by an arithmetic operation by the data interpolation unit based on the read pixel (image) data; and d) outputting the calculated pixel values no be corrected by the output format conversion unit, matching an original clock speed.

In storing the input images (pixels) in the memory in the step b), the input image (pixel) data may be 8 bit data in a YCbCr 4:2:2 format and one image pixel may be configured of luminance signals and chroma signals input for 2 cycles.

The image data may be divided into Y data (luminance data) that are luminance signals and CbCr data (chroma data) that are chroma signals and may be stored in each shifter buffer register and whenever new input data are present, the shifter buffer register may sequentially shift the stored data to store a new value.

The Y data (luminance data) may be stored in the shifter buffer register in a form of Y0Y1, Y1Y2, Y2Y3, Y3Y4, . . . , and the values may be stored in the memory in order, matching a “WRITE cycle” of the PLL clock frequency again increased two times.

The Y data (luminance data) may be stored in the memory at a 16 bit size in a format in which the same Y data overlap so as to acquire two pixel data to be interpolated in a horizontal direction at one timing.

The chroma data may be shifted two times in a format of Cb0Cr1, Cb2Cr3, Cb4Cr5, . . . , without being overlapped and then, may be sequentially stored in the memory at a 16 bit size for the “WRITE Cycle”.

The clock frequency may be increased two times for a period of two consecutive pixel data input for four cycles of the input clock frequency for access to data of the memory for the interpolation in the step b), the input data may be overlappingly stored in the memory through the “WRITE Cycle”, and eight luminance signals and two chroma signals may be acquired through a “READ Cycle” for two pixels to be corrected again.

### BRIEF DESCRIPTION OF THE DRAWINGS

FIG. 1 is a diagram for schematically describing bilinear interpolation.

FIG. 2 is a diagram showing an example of a bilinear interpolation method according to the related art.

FIG. 3 is a diagram showing another example of a bilinear interpolation method using a plurality of line memories according to the related art.

FIG. 4A is a diagram showing image data (photograph) distorted due to a wide angle lens.

FIG. 4B is a diagram showing a general method of correcting image data distorted due to a wide angle lens.

FIG. 5 is a diagram schematically showing a configuration of a bilinear interpolation circuit for an image according to an exemplary embodiment of the present invention.

FIG. 6 is a flow chart showing a performance process of a bilinear interpolation method for an image according to an exemplary embodiment of the present invention.

FIG. 7 is a timing chart showing a process of reading reference pixels to be interpolated while storing image data in a memory of a bilinear interpolation circuit for an image according to the exemplary embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Throughout the specification, unless explicitly described otherwise, “comprising” any components will be understood to imply the inclusion of other components but not the exclusion of any other components. In addition, a term “part”, “module”, “unit”, or the like, described in the specification means a unit of processing at least one function or operation and may be implemented by hardware or software or a combination of hardware and software.

Hereinafter, exemplary embodiments of the present invention will be described with reference to the accompanying drawings.

Here, prior to full-scale description of exemplary embodiments of the present invention, a bilinear interpolation circuit will be first described to help understand the present invention.

As described above, an interpolation method used for a magnification of an image, a distortion correction of an image, a geometrical conversion of an image, and the like, may be variously classified into neighbor pixel interpolation, linear interpolation, cubic interpolation, and the like, according to an algorithm thereof. Generally, the most used interpolation method is the very bi-linear interpolation method having an advantage in terms of complexity and performance. The bilinear interpolation method may be easily configured in hardware and have excellent characteristics.

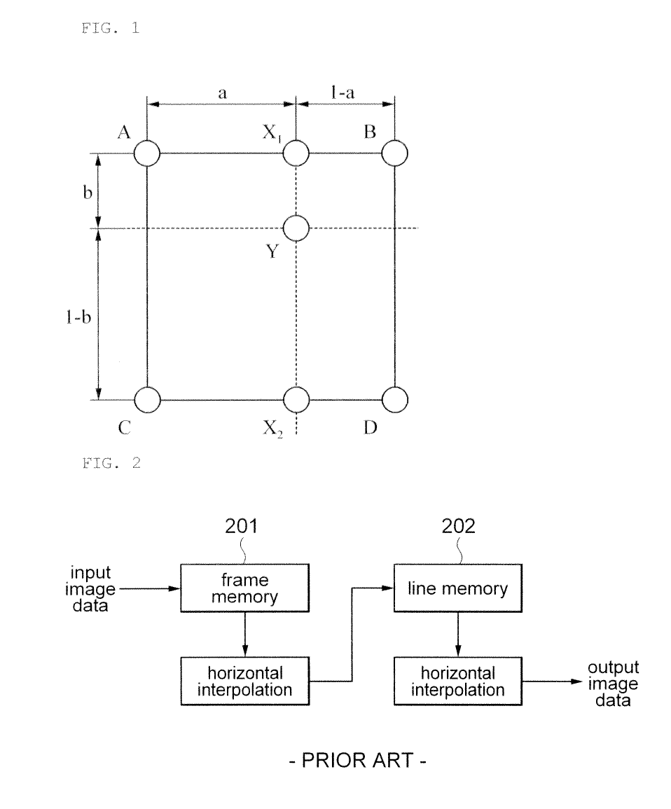

As shown in FIG. 1, the bilinear interpolation is a method of calculating pixel values to be newly generated from data values of four neighbor pixels A to D That is, a final value is calculated by performing a primary linear interpolation in a horizontal direction using weights according to a distance from the four neighbor pixels A to D and again performing a secondary linear interpolation in a vertical direction using horizontally interpolated pixels X₁ and X₂. A bilinear interpolation method is represented by the following Equation 1.

X₁=(1−a)A+aB=A+a(B−A)

X₂=(1−a)C+aD=C+a(D−C)

Y=(1−b)X₁+bX₂=X₁+b(X₂−X₁) [Equation 1]

For configuring the bilinear interpolation circuit, four neighbor pixel values to be referenced need to be read from the memory in which the input images are stored so as to obtain one interpolated pixel value, such that accessibility to the memory is increased, thereby causing a problem in that the real-time processing time is delayed.

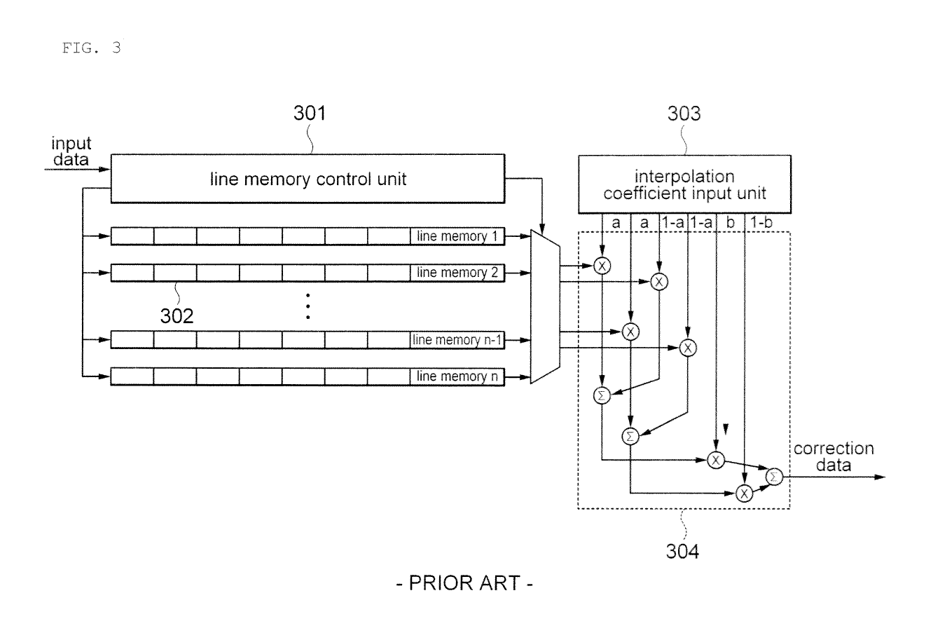

FIG. 2 is a diagram showing an example of a bilinear interpolation method according to the related art.

As shown in FIG. 2, the bilinear interpolation method according to the related art first performs a vertical linear interpolation using a frame memory 201 and then, again stores the processed data in one line memory 202 and again performs a horizontal interpolation, thereby calculating a final pixel value. The method separately performs the vertical and horizontal interpolation to reduce a reading frequency of reference pixels from the memory to two times, thereby solving the delay problem of the processing time, but has a problem of increasing the hardware size by using the frame memory and separately performing the horizontal and vertical interpolation.

FIG. 3 is a diagram showing another example of a bilinear interpolation method using a plurality of line memories according to the related art.

Referring to FIG. 3, the interpolation method according to another example is a method of sequentially storing the input image data in a plurality of line memories 302 and then, simultaneously reading the four pixels to be referenced at the same timing to obtain an interpolation pixel values without the delay time. The method is generally the most frequently used technology at present and has an advantage in that there is no need to store all the frame data and hardware is relatively less complicated, but has a problem in that when the distortion correction or the geometrical conversion of the input images is performed, the number of line memories to be configured according to the referenced interpolation value in a vertical direction is increased proportionately.

At the time of designing a field programmable gate array (FPGA) line memories may increase a complexity of hardware and may degrade the efficiency of a memory. In particular, when an available internal memory like the FPGA is limited according to the specification, configuring a large number of line memories wastes internal memory resources. As a result, the available memory resources may not sufficiently use and using the external memory may also increase the hardware size. In FIG. 3, reference numeral 301 represents a line memory control unit, reference numeral 303 represents an interpolation coefficient input unit, and reference numeral 304 represents a data interpolation unit.

The above problems can be resolved by another interpolation method of increasing a data access speed using an SDRAM in the outside. However, the use of the SDRAM may have a merit in terms of cost, but has a problem in that the hardware size is increased and a high clock frequency is required to use the SDRAM. In addition, the method has a characteristic of randomly forming an access location of the reference pixel for the bilinear interpolation, which means that address values for accessing the memory are not sequentially formed but are randomly formed. Basically, when a memory access speed of the SDRAM is made of a single rather than burst, the speed is remarkably degraded and therefore, the general methods have no choice but to delay the data processing. Therefore, a method for overcoming the above problem is required and therefore, a design of hardware may be complicated.

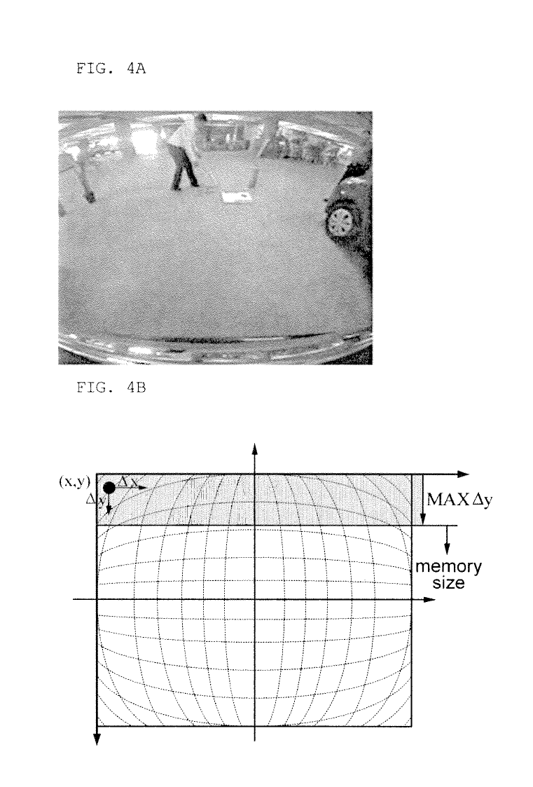

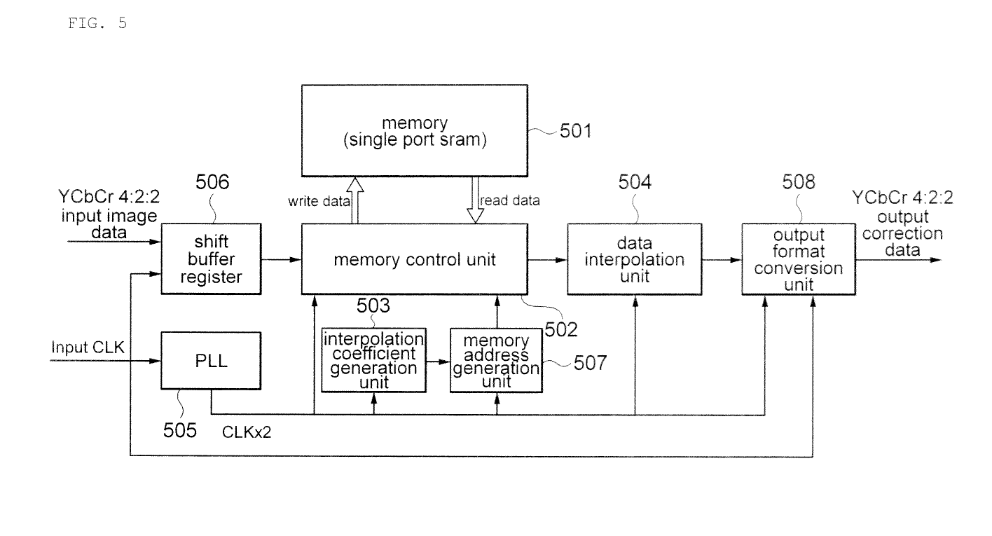

FIGS. 4A and 4B are diagrams showing a general method of correcting image data distorted due to a wide angle lens so as to more facilitate a description of the bilinear interpolation circuit for an image according to the exemplary embodiment of the present invention.

As shown in FIGS. 4A and 4B, in order to correct the image distorted due to the wide angle lens, a process of storing the distorted image input from a camera in the memory and then, again reading the data for correction from the memory is required. To this end, after calculating each coordinate location to be corrected in horizontal and vertical directions according to a lens distortion level based on a center of an image and reading four neighbor pixels based on the calculated coordinates, new pixel values are obtained by the bilinear interpolation circuit. Therefore, a minimum size of the memory in which the input images need to be stored is the same as a product of a horizontal size of the input images and a maximum correction distance MAXΔy to be corrected in a vertical direction.

In the related art, by configuring the line memories having a horizontal size of an image for the above memory so that the line memories have the same number as the maximum correction in a vertical direction, the image data are written in the line memory while alternating input write and read cycles and the four reference pixels to be interpolated are simultaneously read from the four line memories to calculate the distortion corrected pixel values without delaying the processing time due to the data access. However, due to the design as described above, as a distance of coordinates to be corrected in a vertical direction is increased, the number of line memories is increased, such that the complexity and the size of the interpolation circuit according to the design of the memory bus may be increased and it is impossible to use the external memory. In addition, the efficiency of the memory is degraded and a logic is unnecessarily increased, due to the separation of the available resources of the internal memory into several line memories at the time of designing the circuit based on the FPGA. As a result, higher specification of FPGA is used and thus, costs may be increased.

The present invention is proposed to improve the above problems. The present invention is to provide the bilinear interpolation circuit and the method thereof capable of reducing the data processing time and the hardware size by reading the data referenced for interpolation from the memory while writing the input image data in the single SRAM in the configuration of the bilinear interpolation circuit.

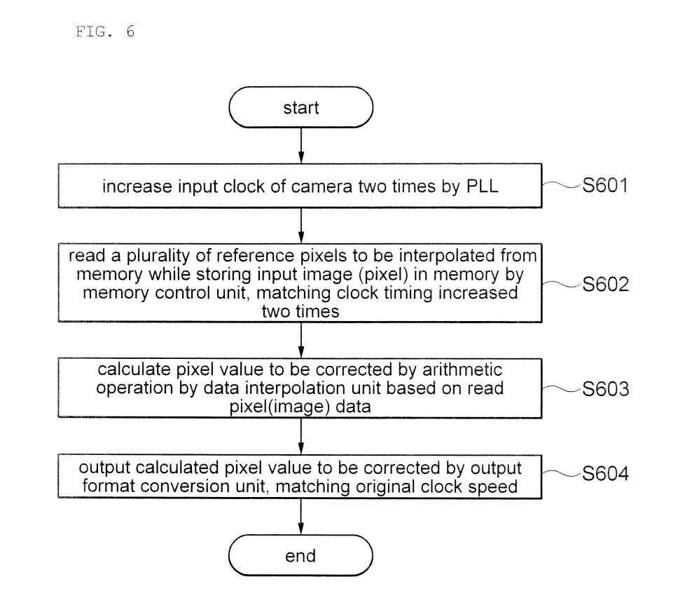

FIG. 5 is a diagram schematically showing a configuration of a bilinear interpolation circuit for an image according to an exemplary embodiment of the present invention.

Referring to FIG. 5, the bilinear interpolation circuit according to the exemplary embodiment of the present invention includes a memory 501, a memory control unit 502, an interpolation coefficient generation unit 503, and a data interpolation unit 504.

The memory stores input image data and reference pixel data tor interpolation. Here, ail of the general memory devices can be used as the memory 501. Preferably, the memory is configured of an SRAM having single input and output port. In addition, the SRAM can be installed inside or outside the circuit.

The memory control unit 502 stores the input image data in the memory 501 and reads the pixel data to be referenced from the memory 501 for the interpolation of an image. Here, the memory control unit 502 as described above reads the plurality of reference pixels to be interpolated from the memory 501 while storing the input image data in the memory 501.

The interpolation coefficient generation unit 503 calculates coordinate values to be corrected for each pixel to generate the interpolation coefficients.

The data interpolation unit 504 calculates the pixel values to be corrected from the reference pixels read by the memory control unit 502 based on the correlation coefficients generated by the interpolation coefficient generation unit 503.

Here, the memory control unit 502 as described above reads four reference pixels to be interpolated from the memory 501 while storing the input image data in the memory 501.

Preferably, the bilinear interpolation circuit according to the exemplary embodiment of the present invention further includes a phase locked loop (PLL) 505 that increases an input clock of a camera two times and provides the increased input clock to the memory control unit 502, the interpolation coefficient generation unit 503, and the data interpolation unit 504, a shifter buffer resistor 506 that transmits the input image data to the memory control unit 502 while overlapping and storing the input image data, matching the input clock, a memory address generation unit 507 that generates a memory address to be referenced and provides the generated memory address to the memory control unit 502, and an output format conversion unit 508 that outputs 504, matching an original clock speed.

Next, the bilinear interpolation method for an image by the bilinear interpolation circuit for an image according to the exemplary embodiment of the present invention having the above configuration will be described below.

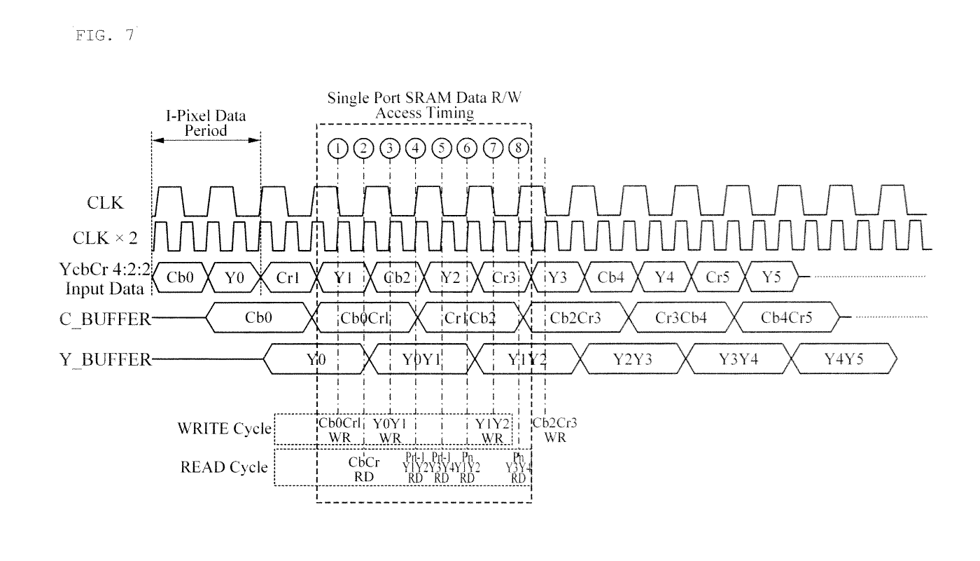

FIG. 6 is a flow chart showing a performance process of a bilinear interpolation method for an image according to an exemplary embodiment of the present invention.

Referring to FIG. 6, the bilinear interpolation method for an image according to the present invention is a bilinear interpolation method for an image by the bilinear interpolation circuit for an image including the memory 501, the memory control unit 502, the interpolation coefficient generation unit 503, the data interpolation unit 504, and the like, as described above, and first increases the input clock of the camera two times by the PLL 505 (S601).

Next, the input image (pixel) data are stored in the memory 501 by the memory control unit 502, matching the clock timing increased two times and at the same time, the plurality (for example, four) of reference pixels to be interpolated are read from the memory 501 (S602). Here, the input image (pixel) data, that is, the camera image data are input in a YCbCr 4:2:2 format and one image pixel as 8 bit data of the YCbCr 4:2:2 format is represented by luminance signals and chroma signals input for 2 cycles.

When the reference pixels to be interpolated are read, the pixel values to be corrected are calculated by performing an arithmetic operation by the data interpolation unit 504 based on the read pixel (image) data (S603).

Next, the calculated pixel values to be corrected are output by the output formation conversion unit 508, matching the original clock speed (S604).

Here, a process of storing and interpolating a series of image data as described above will be described in more detail with reference to FIG. 7.

FIG. 7 is a timing chart showing a process of reading the reference pixels to be interpolated while storing the image data in the memory of the bilinear interpolation circuit for an image according to the exemplary embodiment of the present invention.

Referring to FIG. 7, the camera image data are input in the YCbCr 4:2:2 format. In addition, the camera input clock is increased two times by the PLL 505. The memory control unit 502 reads the four reference pixels to be interpolated while storing the input pixels in the memory (SRAM) 501, matching the new clock timing increased two times. Here, the input image data are the 8 bit data in the YCbCr 4:2:2 format, wherein one image pixel is represented by luminance signals and chroma signals input for 2 cycles. The image data are divided into Y data (luminance data) that are luminance signals and CbCr data (chroma data) that are chroma signals and are stored in each shifter buffer register 506 and whenever the new input data are present, the shifter buffer register 506 sequentially shifts the stored data to store a new value. In this case, the Y data (luminance data) are stored in the shifter buffer register 506 in a format such as Y0Y1, Y1Y2, Y2Y3, Y3Y4, . . . , and the values are stored in the memory (SRAM) 501 in order, matching the “WRITE Cycle” of the PLL clock frequency again increased two times. In this case, as shown in FIG. 7, the Y data (luminance data) are stored in the memory 501 at a 16 bit size in a form in which the same Y data overlap, which is to obtain two pixel data to be interpolated in a horizontal direction at one timing. On the other hand, the chroma data are shifted two times in a format such as Cb0Cr1, Cb2Cr3, Cb4Cr5, . . . , without being overlapped and then, are sequentially stored in the memory (SRAM) 501 at a 16 bit size for the “WRITE Cycle”. Reading the four reference pixels required to interpolate one luminance pixel can be acquired by a two-times memory access of number \textcircled{2}. The reason is that the reference pixels to be interpolated in the horizontal direction are overlappingly stored as described above. Here, all of the four reference pixels can be read by reading two data having different vertical locations. The pixel required to correct the chroma pixel can be corrected by reading the chroma pixel once per the two consecutive pixels to be corrected and then, transmitting the read chroma pixel as it is, matching a 4:2:2 output format, without interpolating Cb and Cr. The reason is that the importance of the chroma signals is more remarkably degraded than that of the luminance signals in the image quality. That is, the reason is that the luminance signals are corrected to an accurate value by the bilinear interpolation but the chroma signals are corrected using a neighbor pixel interpolation method. That is, the exemplary embodiment of the present invention performs the bilinear interpolation without delaying the processing time, by increasing the clock frequency two times for a period of the two consecutive pixel data input for four cycles of the input clock frequency for access to data of the memory (SRAM) 501 for the bilinear interpolation, overlappingly storing the input data in the memory 501 through the “WRITE Cycle” of number \textcircled{3}, and acquiring eight luminance signals and two chroma signals through the “READ Cycle” of number \textcircled{5} for two pixels to be corrected again. In this case, the “WRITE Cycle” is performed at a rising edge of number \textcircled{1}, \textcircled{3}, and \textcircled{7} of a clock in FIG. 7 and the “READ Cycle” is performed at a rising edge of number \textcircled{2}, \textcircled{4}, \textcircled{5}, \textcircled{6}, and \textcircled{8} of a clock. The data interpolation unit 504 calculates the pixel values to be corrected by the arithmetic operation based on the acquired image data. Then, the output format conversion unit 508 finally outputs the pixel values to be corrected in the YCbCr 4:2:2 format, again matching the cycle of the original clock frequency.

As described above, the bilinear interpolation circuit for an image according to the exemplary embodiment of the present invention uses the SRAM having a single input and output port during the process of storing the input image data in the memory and again reading the stored image data for interpolation, thereby making it possible to read the plurality of pixels required for interpolation while storing the pixels in the memory for a period of the two input pixel data without delaying the processing time.

In addition, the exemplary embodiment of the present invention can prevent the increase in the size of the circuit or the complexity of the circuit due to the excessive use of the line memory according to the correction at the time of implementing the interpolation circuit according to the image conversion using the FPGA or the ASIC and can locate a single SRAM inside or outside the circuit to perform the correction without the additional design of the memory even though the input data to be stored is changed.

In addition, the exemplary embodiment of the present invention can configure the system that can be easily designed and consume low power by more reducing the complexity of the circuit and the clock frequency than using the SDRAM in the outside.

According to the exemplary embodiments of the present invention, it is possible to reduce the data processing time by reading the plurality of image data referenced for interpolation from the memory while writing the input image data in the memory and reduce the hardware size by using the SRAM having a single input and output port as the memory.

As described above, the present invention will be described with reference to the exemplary embodiments, but is not limited thereto. It can be apparent to those skilled in the art that the exemplary embodiments of present invention can be variously changed and applied within the scope of the present invention without departing from the technical idea of the present invention. Therefore, the protection scope of the present invention must be construed by the appended claims and it should be construed that all spirits within a scope equivalent thereto are included in the appended claims of the present invention.

What is claimed is:

1. A bilinear interpolation circuit for an image, comprising:
a memory in which input image data and reference pixel data for interpolation are stored;
a memory control unit storing the input image data in the memory and reading the reference pixel data from the memory for interpolation of an image;
an interpolation coefficient generation unit calculating coordinate values to be corrected for each pixel to generate interpolation coefficients; and
a data interpolation unit calculating pixel values to be corrected from the reference pixels read by the memory control unit based on the interpolation coefficients generated by the interpolation coefficient generation unit,
wherein the memory is formed of an SRAM having a single input and output port and the memory control unit reads the plurality of reference pixels to be interpolated from the memory while storing the input image data in the memory.

2. The bilinear interpolation circuit according to claim 1, wherein the memory control unit reads four reference pixels to be interpolated from the memory while storing the input image data in the memory.

3. The bilinear interpolation circuit according to claim 1, further comprising:
a phase locked loop (PLL) increasing an input clock of a camera two times and providing the increased input clock to the memory control unit, the interpolation coefficient generation unit, and the data interpolation unit;
a shift buffer register transmitting the input image data to the memory control unit while overlappingly storing the input image data, matching the input clock;
a memory address generation unit generating memory addresses to be referenced and providing the generated memory addresses to the memory control unit; and
an output format conversion unit outputting pixel values to be corrected calculated by the data interpolation unit, matching an original clock speed.

4. A bilinear interpolation method for an image by a bilinear interpolation circuit for an image including a memory, a memory control unit, an interpolation coefficient generation unit, and a data interpolation unit, the bilinear interpolation method comprising:
a) increasing an input clock of a camera two times by a PLL;
b) reading a plurality of reference pixels to be interpolated from the memory while storing input images (pixels) in the memory by the memory control unit, matching a clock timing increased two times;
c) calculating pixel values to be corrected by an arithmetic operation by the data interpolation unit based on the read pixel (image) data; and
d) outputting the calculated pixel values to be corrected by the output format conversion unit, matching an original clock speed.

5. The bilinear interpolation method according to claim 4, wherein in storing the input images (pixels) in the memory in the step b), the input image (pixel) data are 8 bit data in a YCbCr 4:2:2 format and one image pixel is configured of luminance signals and chroma signals input for 2 cycles.

6. The bilinear interpolation method according to claim 5, wherein the image data are divided into Y data (luminance data) that are luminance signals and CbCr data (chroma data) that are chroma signals and are stored in each shifter buffer register and whenever new input data are present, the shifter buffer register sequentially shifts the stored data to store a new value.

7. The bilinear interpolation method according to claim 6, wherein The Y data (luminance data ) are stored in the shifter buffer register in a form of Y0Y1, Y1Y2, Y2Y3, Y3Y4, . . . , and the values are stored in the memory in order, matching a “WRITE cycle” of the PLL clock frequency again increased two times.

8. The bilinear interpolation method according to claim 7, wherein the Y data (luminance data) are stored in the memory at a 16 bit size in a format in which the same Y data overlap so as to acquire two pixel data to be interpolated in a horizontal direction at one timing.

9. The bilinear interpolation method according to claim 6, wherein the chroma data are shifted two times in a format of Cb0Cr1, Cb2Cr3, Cb4Cr5, . . . , without being overlapped and then, are sequentially stored in the memory at a 16 bit size for the “WRITE Cycle”.

10. The bilinear interpolation method according to claim 4, wherein a clock frequency is increased two times for a period of two consecutive pixel data input for four cycles of the input clock frequency for access to data of the memory for the interpolation in the step b), the input data are overlappingly stored in the memory through the “WRITE Cycle”, and eight luminance signals and two chroma signals are acquired through a “READ Cycle” for two pixels to be corrected again.
